(19) United States
(12) Patent Application Publication
(10) Pub. No.: US 2017/0145314 A1
(43) Pub. Date: May 25, 2017

(54) WASTE PROCESSING APPARATUS AND METHOD OF FEEDING WASTE

(71) Applicant: DPS Bristol (Holdings) Limited, Portishead (GB)

(72) Inventor: David John Parkinson, Clevedon (GB)

(73) Assignee: DPS Bristol (Holdings) Limited, Portishead (GB)

(21) Appl. No.: 15/323,731

(22) PCT Filed: Jul. 2, 2015
(86) PCT No.: PCT/GB2015/051938

§ 371 Date: Jan. 3, 2017

(30) Foreign Application Priority Data
Jul. 3, 2014 (GB) 1411922.6

(51) Int. Cl. C10B 41/00; C10B 53/00; C10B 5/00; F27D 3/08; B65G 33/14; B65G 65/46; B65G 33/34; C10B 47/30; C10B 31/10

(52) U.S. Cl. CPC C10B 41/005; C10B 47/30; C10B 53/00; C10B 5/00; C10B 31/10; B65G 33/14; B65G 65/463; B65G 33/34; F27D 3/08

(57) ABSTRACT

A waste processing apparatus may include a pyrolyser and a feed assembly. The feed assembly may include a feed duct including a waste inlet configured to receive waste. The feed duct may further include a waste outlet configured to discharge the waste from the feed duct to the pyrolyser. The feed assembly may also include a feed screw disposed within the feed duct configured to convey the waste from the waste inlet to the waste outlet. The feed assembly may further include a rotary drive configured to cause the feed screw to convey the waste from the waste inlet to the waste outlet. The feed assembly may also include a rotational resistance sensor configured to monitor a parameter related to resistance to rotation. The feed assembly may further include a rotary drive controller configured to reduce, based on the parameter, a rotary output speed of the rotary drive.

The invention relates to waste processing apparatus comprising a feed assembly and a pyrolyser.

It is known to process waste by pyrolysis and gasification in modular waste processing apparatus including separate pyrolysis and gasifiers. Pyrolysis is the thermal decomposition of matter under the action of heat alone (i.e. in the absence of oxygen), and is an endothermic process. During pyrolysis, a pyrolysis feedstock (such as human or consumer waste) is decomposed to form pyrolysis char and combustible pyrolysis gas.

Gasification is the exothermic reaction of carbonaceous matter, such as pyrolysis char, with oxygen and/or steam to produce combustible syngas. Syngas may include hydrogen, carbon monoxide and carbon dioxide.

The resulting pyrolysis gas and syngas can be combusted to provide thermal energy to sustain the pyrolysis process, and any remaining thermal energy can be converted (e.g. to electricity using a generator) or used onsite.

However, known waste processing apparatus for separately conducting pyrolysis, gasification and combustion suffer from a number of problems.

In particular, feed assemblies for pyrolysers are typically required to provide a seal to inhibit the ingress of oxygen or other gases into the pyrolyser. However, previously considered designs for feed assemblies are known to result in blockages at the seal. For example, a previously considered feed assembly comprises a compaction cone for compacting waste so that it forms a seal against the feed assembly, and is particularly susceptible to blockages. For example, blockages may occur where the waste cannot be sufficiently radially compacted to pass through the compaction cone.

It is therefore desirable to provide an improved feed assembly for waste processing apparatus.

According to an aspect of the invention there is provided waste processing apparatus comprising: a pyrolyser; and a feed assembly comprising: a feed duct having a waste inlet for receiving waste and a waste outlet for discharging waste from the feed duct towards the pyrolyser; and a variable pitch feed screw disposed within the feed duct for conveying waste from the waste inlet to the waste outlet; wherein the pitch of the feed screw reduces along its length in a direction from the waste inlet to the waste outlet so that in use waste received in the feed duct is compacted as it is conveyed from the waste inlet to the waste outlet.

The pitch of the feed screw may progressively reduce along its length. The pitch of the feed screw may continuously reduce along its length.

The waste inlet may be formed towards one end of the feed duct and the waste outlet may be formed at the opposing end. The duct may be substantially longitudinal and the waste inlet may be formed in the longitudinal wall of the duct. For example, the waste inlet may be formed in an upper portion of the longitudinal wall of the duct when the duct extends substantially longitudinally. Alternatively, the waste inlet may be formed in the underside of the longitudinal wall (i.e. a lower portion) of the duct so that the waste inlet may receive waste from a further feed duct. The waste outlet may comprise an open end of the duct.

The variable pitch feed screw may be configured so that in use waste received in the feed duct is compacted so as to seal against the feed duct. The waste sealing against the feed duct may restrict or prevent the flow of gases into the pyrolyser through the feed duct. The waste processing apparatus may operate at negative pressure relative to the ambient air pressure.

The variable pitch feed screw and the feed duct may be configured so that in use waste received in the feed duct seals against a portion of the feed duct having a constant diameter. Alternatively, the variable pitch feed screw and feed duct may be configured so that in use waste received in the feed duct seals against a portion of the feed duct having a tapering diameter. The portion of the feed duct having a tapering diameter may be a compaction cone configured to compact the waste as it is conveyed through the feed duct. The compaction cone portion of the feed duct may reduce in diameter towards the waste outlet.

References to the diameter or profile of the feed duct herein relate to the internal dimensions and internal profile of the feed duct—i.e. the internal wall of the duct.

The variable pitch feed screw may be configured to compact waste received in the feed duct against an opposing surface by rotation relative to the opposing surface. The variable pitch feed screw may comprise an external screw flight mounted to a shaft rotatable with respect to the feed duct. The opposing surface may be the inner surface of the feed duct. The feed duct may be static and the shaft and external screw flight (i.e. the variable pitch feed screw) may be rotatable. Alternatively, the shaft and external screw flight may be static and the feed duct may be rotatable.

The variable pitch feed screw may comprise an internal screw flight mounted to the internal surface of the feed duct. The opposing surface may be the outer surface of a shaft (or core) disposed within the feed duct. The shaft may be static and the feed duct may be rotatable. Alternatively, the feed duct may be static and the shaft may be rotatable.

The shaft may be cylindrical or alternatively may be of variable diameter. For example, the shaft may be conical or may have a conical section. The conical section may increase in diameter towards the outlet of the feed duct.

The diameter of the screw flight may be substantially constant or alternatively the screw flight may be of variable diameter. For example, the screw flight may have a conical profile which may increase in diameter towards the outlet of the feed duct.

The feed screw may have a single thread or it may comprise multiple threads.

The pitch of the feed screw may reduce along its length by a ratio of 2:1 The pitch of the feed screw towards the waste inlet may be 380 mm, and the pitch of the feed screw towards the waste outlet may be 190 mm. The pitch of the feed screw may reduce continuously over its length. Alternatively, each of a plurality of portions of the feed screw may have different fixed pitches. For example, the feed screw may have four portions of fixed pitch such as 380 mm, 300 mm, 250 mm and 200 mm in a direction from the waste inlet to the waste outlet.

The feed duct may be substantially tubular.

The variable pitch feed screw may be rotatable relative the feed duct and may be configured so that in use waste received in the feed duct is compacted against the feed duct when the feed screw rotates relative to the feed duct.

The feed screw may be substantially coextensive with the feed duct. The feed screw may extend out of the waste outlet and partly into the pyrolyser. The feed screw may be coaxial with the feed duct.

There may be two feed ducts arranged in series with each other, and the variable pitch feed screw may be disposed within one of the feed ducts. There may be a primary feed duct and a secondary feed duct, the primary waste duct having a primary waste inlet for receiving waste and a primary waste outlet for discharging waste to the secondary feed duct, the secondary feed duct having a secondary waste inlet for receiving waste from the primary feed duct and a secondary waste outlet for discharging waste into the pyrolyser, and the variable pitch feed screw may be disposed within one of the primary and secondary feed ducts.

The other of the primary and secondary feed ducts may have a constant-pitch feed screw. Alternatively, there may be two variable pitch feed screws, each disposed within a respective one of the primary and secondary feed ducts.

The feed assembly may further comprise a hopper for receiving waste from an external waste source and providing waste to the waste inlet of the feed duct. The hopper may comprise a rotary drum airlock which may inhibit or prevent the ingress of air into the waste processing apparatus. For example, the rotary drum airlock may have a chamber having a radial opening that is open to the external source in a first configuration of the airlock so that it can be filled with waste from the external waste source, and which can be rotated to a second configuration in which the radial opening is open to the feed duct so as to provide the waste from the chamber to the waste inlet of the feed duct.

According to a further aspect of the invention there is provided waste processing apparatus comprising: a pyrolyser; and a feed assembly comprising: a feed duct having a waste inlet for receiving waste and a waste outlet for discharging waste from the feed duct towards the pyrolyser; a feed screw disposed within the feed duct for conveying waste from the waste inlet to the waste outlet; a rotary drive for causing the feed screw to convey waste from the waste inlet to the waste outlet; a rotational resistance sensor for monitoring a parameter relating to resistance to rotation; and a rotary drive controller configured to cause the rotary-output-speed of the rotary drive to reduce when the monitored parameter indicates excessive resistance to rotation.

The feed screw may be configured to convey waste from the waste inlet to the waste outlet by rotation relative to an opposing surface of the feed assembly.

The feed screw may comprise an external screw flight mounted to a shaft rotatable with respect to the feed duct. The opposing surface may be the inner surface of the feed duct. The feed duct may be static and the shaft and external screw flight may be rotatable. Alternatively, the shaft and external screw flight may be static and the feed duct may be rotatable.

The feed screw may comprise an internal screw flight mounted to the internal surface of the feed duct. The opposing surface may be the outer surface of a shaft (or core) disposed within the feed duct. The shaft may be static and the feed duct may be rotatable. Alternatively, the feed duct may be static and the shaft may be rotatable.

The rotary drive may be for causing relative rotation between the feed screw and the opposing surface. For example, the rotary drive may be coupled to the feed screw for rotating the feed screw relative to the feed duct. It will be appreciated that the rotary drive can be coupled to whichever component of the feed assembly is to be rotated to cause the feed screw to convey waste from the waste inlet to the waste outlet.

The rotational resistance sensor may be configured to monitor a parameter relating to the resistance of the feed screw to rotation, for example, the resistance caused by a blockage of waste in the feed duct, in the pyrolyser or between the feed duct and the pyrolyser.

The rotational resistance sensor may be configured to monitor a parameter relating to the torque applied by the rotary drive. The rotational resistance sensor may be configured to monitor a parameter relating to the power consumption of the rotary drive. The rotational resistance sensor may be a torque sensor. The rotational resistance sensor may be a current meter and/or a voltage meter.

The sensor may be a torque sensor for generating a signal relating to the torque applied by the rotary drive to the feed assembly.

The rotary drive controller may be configured to reduce the rotary-output-speed of the rotary drive when the monitored parameter is outside a predetermined range or the rate of change of the monitored parameter exceeds a predetermined threshold (i.e. when the monitored parameter indicates that the resistance to rotation is excessive). The predetermined range may relate to an acceptable torque range of up to 18000 Nm. The predetermined threshold for the rate of change of the monitored parameter may relate to a rate of change in torque of 1000 Nm/s. The predetermined threshold for the rate of change of the monitored parameter may relate to a percentage of the maximum acceptable torque per second.

The rotary drive controller may be configured to cause the rotary-output-speed of the rotary drive to reduce to a positive rotary speed when the monitored parameter indicates excessive resistance to rotation so that the feed screw continues to convey waste from the waste inlet to the waste outlet. The rotary drive controller may be configured to cause the rotary-output-speed to temporarily reduce when the monitored parameter indicates excessive resistance to rotation. The rotary drive controller may be configured to cause the rotary-output-speed to increase from a reduced rotary-output-speed when the monitored parameter indicates that the resistance to rotation is no longer excessive.

The rotary drive controller may be configured to cause the rotary-output-speed of the rotary drive to reduce so that the rotary drive temporarily reverses when the monitored parameter indicates excessive resistance to rotation. The rotary drive controller may be configured to reverse the rotary drive when the monitored parameter is outside a predetermined range. There may be a first predetermined range which may relate to an acceptable torque range, such as up to 180000 Nm, and the rotary drive controller may be configured to reduce the rotary-output-speed of the rotary drive when the monitored parameter is outside the first predetermined range. There may be a second predetermined range which may relate to a critical torque range, such as up to 200000 Nm, and the rotary drive controller may be configured to reduce the rotary-output-speed of the rotary drive so that the rotary drive temporarily operates in reverse when the monitored parameter is outside of the second predetermined range. The rotary-drive controller may be configured to operate the rotary drive in reverse for a limited time, such as four seconds. The rotary-drive controller may be configured to shutdown the feed assembly and/or initiate an alarm when a predetermined number of reversals are initiated in a predetermined period of time. For example, the feed assembly may be shutdown when there are four or more reversals of the rotary drive in one minute.

The rotary drive controller may be configured to reduce the rotary-output-speed of the rotary drive by reducing the power consumption of the rotary drive, for example by limiting the current provided to the rotary drive. The rotary drive may be coupled to the feed screw so as to cause the feed screw to rotate relative to the feed duct at the rotary-output-speed of the rotary drive.

There may be two feed ducts arranged in series with each other; and the feed screw, rotary drive, rotational resistance sensor and rotary drive controller may be associated with one of the feed ducts. The feed assembly may further comprise a second feed screw and second rotary drive associated with the other of the feed ducts, and the rotary drives may be coupled so that their rotary-output-speeds are related. Alternatively, each feed duct may be provided with a separate feed screw, rotary drive, rotational resistance sensor and rotary drive controller configured to independently monitor for excessive resistance to rotation. The two rotary drives may be coupled so that their rotary-output-speeds are related. Accordingly, irrespective of where excessive resistance to rotation is experienced, the rotary-output-speeds of the rotary drives associated with both feed ducts will both be reduced.

According to a further aspect of the invention there is provided a method of feeding waste from a feed assembly to a pyrolyser, the feed assembly comprising a feed duct having a waste inlet for receiving waste and a waste outlet for discharging waste from the feed duct towards the pyrolyser; a feed screw disposed within the feed duct for conveying waste from the waste inlet to the waste outlet; and a rotary drive for causing the feed screw to convey waste from the waste inlet to the waste outlet, the method comprising: receiving waste in the waste inlet of the feed duct; controlling the rotary drive to cause the feed screw to convey waste from the waste inlet to the waste outlet; monitoring a parameter relating to resistance to rotation; controlling the rotary drive to cause the rotary-output-speed of the rotary drive to reduce when it is determined that the monitored parameter indicates excessive resistance to rotation.

The rotary drive may be coupled to the feed screw to rotate the feed screw relative to the feed duct. The monitored parameter may relate to the resistance to rotation experienced by the rotary drive when coupled to the feed screw to rotate the feed screw. For example, excessive resistance to rotation may be caused by a blockage of waste in the feed duct, in the pyrolyser or between the feed duct and the pyrolyser.

The monitored parameter may relate to the torque applied by the rotary drive. The monitored parameter may relate to the power consumption of the rotary drive.

Determining that the monitored parameter indicates excessive resistance to rotation may comprise determining whether the monitored parameter is outside a predetermined range or whether the rate of change of the monitored parameter exceeds a predetermined threshold.

The rotary-output-speed of the rotary drive may be reduced to a positive rotary speed when the monitored parameter indicates excessive resistance to rotation so that the feed screw continues to convey waste from the waste inlet to the waste outlet. The rotary-output-speed may be temporarily reduced when the monitored parameter indicates excessive resistance to rotation. The method may further comprise increasing the rotary-output-speed of the rotary drive from a reduced speed when it is determined that the resistance to rotation is no longer excessive.

The rotary-output-speed of the rotary drive may be reduced by limiting the power consumption of the rotary drive. The rotary-output-speed of the rotary drive may be reduced by reducing (i.e. limiting) the power consumption of the rotary drive, for example by limiting the current supply to the rotary drive.

The rotary drive may be coupled to the feed screw so as to cause the feed screw to rotate relative to the feed duct at the rotary-output-speed of the rotary drive.

Throughout the description and claims of this specification, the words “comprise” and “contain” and variations of the words, for example “comprising” and “comprises”, mean “including but not limited to”, and do not exclude other moieties, additives, components, integers or steps. Moreover the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Other features of the invention will become apparent from the following examples. Generally speaking the invention extends to any novel one, or any novel combination, of the features disclosed in this specification (including any accompanying claims and drawings). Thus features, integers or characteristics described in conjunction with a particular aspect, embodiment or example of the invention are to be understood to be applicable to any other aspect, embodiment or example described herein unless incompatible therewith. Moreover unless stated otherwise, any feature disclosed herein may be replaced by an alternative feature serving the same or a similar purpose.

Where upper and lower limits are quoted for a property, then a range of values defined by a combination of any of the upper limits with any of the lower limits may also be implied.

The invention will now be described by reference to the following drawings, in which:

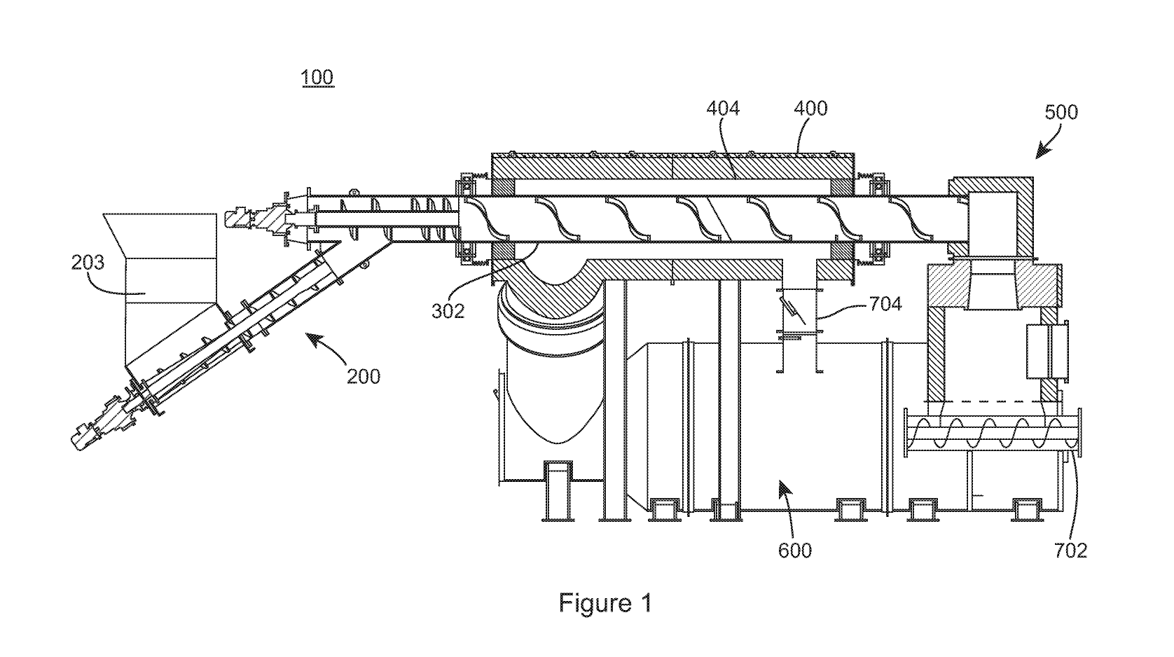

FIG. 1 schematically shows waste processing apparatus according to an embodiment of the invention;

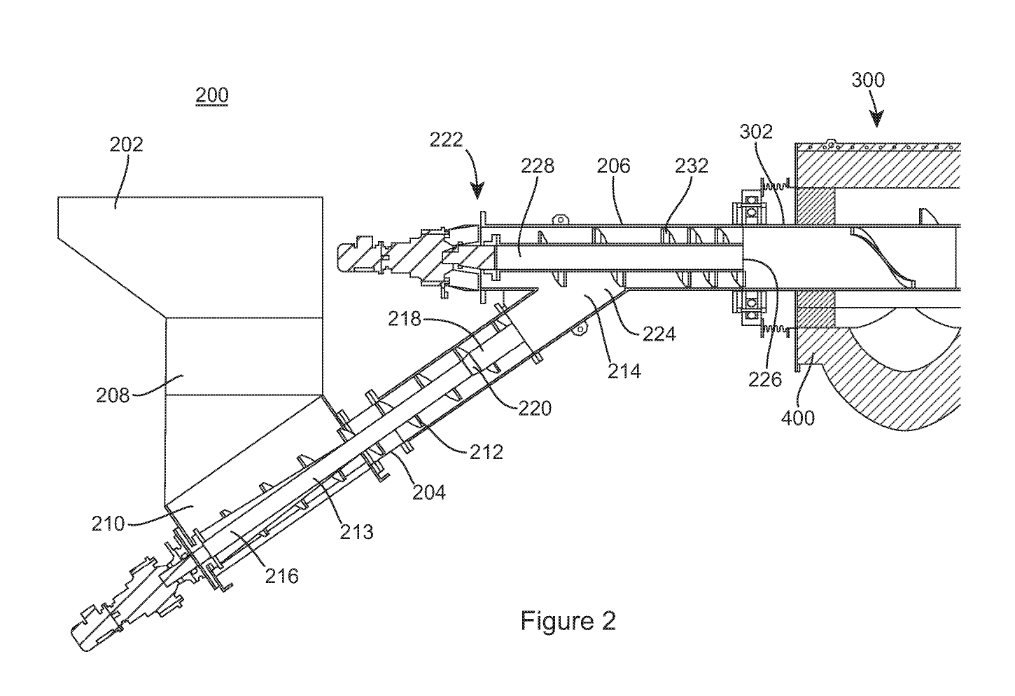

FIG. 2 shows a feed assembly for the waste processing apparatus of FIG. 1;

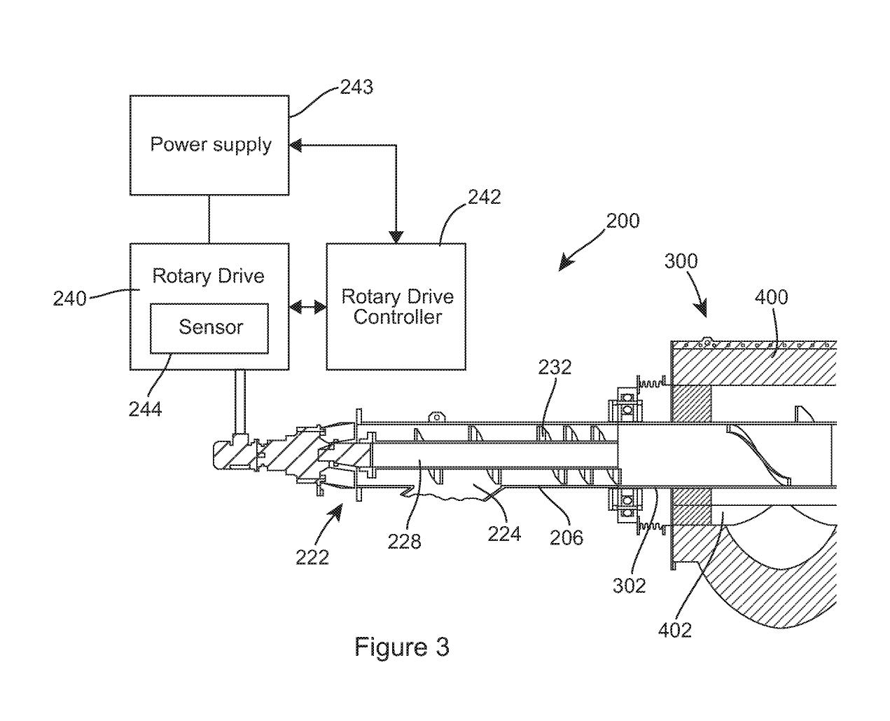

FIG. 3 shows the secondary feed duct and secondary feed screw of the feed assembly of FIG. 2.

FIG. 1 shows waste processing apparatus 100 comprising a feed assembly 200, a pyrolyser 300 including a rotary kiln or rotary pyrolysis tube 302 and a heating vessel 400, a gasifier 500 and an oxidiser 600.

In use, waste is received in the feed assembly 200 and conveyed into the rotary pyrolysis tube 302 of the pyrolyser 300 where it is decomposed under the action of heat to form pyrolysis char and pyrolysis gas. The rotary pyrolysis tube 302 is disposed within the heating chamber 404 of the heating vessel 400, and heat is transferred to the rotary pyrolysis tube 302 from hot gases received within the heating chamber 404. The pyrolysis char and pyrolysis gas exit the rotary pyrolysis tube 302 to enter the gasifier 500, where the pyrolysis char is gasified by the introduction of oxygen and/or steam to produce syngas and ash. The pyrolysis gas and syngas flow together from the gasifier 500 to the oxidiser 600, where the gas is combusted to produce hot gas. The hot gas is redirected to the heating chamber 404 of the heating vessel 400 to heat the rotary pyrolysis tube 302. The hot gas is then directed from the heating chamber 404 to a separate heat recovery unit, such as a steam turbine for power generation.

Ash formed in the gasifier and collected in the oxidiser and heating chamber is collected in an ash bin (not shown) of an ash collection unit by a number of ash feed ducts 702, 704.

As shown in FIG. 2 the feed assembly 200 comprises a hopper 202 for receiving waste for processing, a primary feed duct 204 arranged to receive waste from the hopper 202 and discharge waste to a secondary feed duct 206, which itself discharges the waste to the rotary pyrolysis tube 302.

The hopper 202 comprises a rotary drum airlock 203 for receiving waste from an external waste source and dispensing waste to the primary feed duct 204. The rotary drum airlock has a chamber having a radial opening, and is rotatable between a first configuration in which the radial opening is directed upwardly and open to the external waste source to receive waste, and a second configuration in which the radial opening is directed downwardly and open to dispense waste to the primary feed duct 204. Accordingly, the rotary drum airlock 203 prevents the continuous ingress of atmospheric air from outside the feed assembly into the feed assembly.

A hopper duct 208 extends downwardly from the hopper 202 to a waste inlet 210 of the primary feed duct 204 formed in an upper portion of the cylindrical duct wall of the primary feed duct 204. The primary feed duct 204 is inclined at approximately 30° to the horizontal and a primary feed screw 212 mounted on a primary shaft 213 is coaxially disposed within the primary feed duct 204. The primary feed screw 212 is configured to convey the waste material received therein upwardly along the primary feed duct from the primary waste inlet 210 at the upper end to a primary waste outlet 214 at the upper end, which is the junction between the primary feed duct 204 and the secondary feed duct 206. The primary shaft 213 for the primary feed screw 212 is cantilever mounted in the lower end wall of the primary feed duct by a bearing and seal assembly, and is coupled to a primary rotary drive (not shown) disposed outside of the primary feed duct 204 to rotate at a rotary-output-speed of the primary rotary drive. The primary shaft 213 has a narrow portion 216 towards the primary waste inlet 210 having a first constant diameter, a wide portion 218 towards the primary waste outlet 214 having a larger second diameter, and a relatively short conical portion 220 therebetween. The conical portion 220 and wide portion 218 of the primary shaft 213 have the effect of reducing the cross-sectional space in the primary feed duct 204 so that waste conveyed along the duct 204 is compacted as it passes the conical and wide portions 220, 218 so as to form a plug seal between the waste, the duct 204 and the shaft 213.

The secondary feed duct 206 extends substantially horizontally from a closed end 222 to a secondary waste outlet 226 in communication with the open inlet end of the pyrolysis tube 302. A secondary waste inlet 224 is formed in a lower portion of the cylindrical duct wall towards the closed end 222 at the junction between the primary feed duct 204 and secondary feed duct 206 so as to receive waste from the primary waste outlet 214. Accordingly, the primary and secondary feed ducts 204, 206 are arranged in series.

A secondary shaft 228 is cantilever mounted by a bearing and seal assembly in the end wall 222 of the secondary duct 206 and extends from a secondary rotary drive outside of the secondary feed duct 206 coaxially along the secondary feed duct 206. The shaft 228 supports a secondary feed screw 232 which varies in pitch along the length of the screw in a direction from the secondary waste inlet 224 or end wall 222 towards the secondary waste outlet 226.

The variable pitch feed screw 232 is configured to convey waste received from the primary feed duct 204 along the secondary feed duct 206 and through the secondary waste outlet 226 into the pyrolysis tube 302. The pitch of the feed screw 210 relates to the axial distance between successive threads. The pitch of the secondary feed screw 232 decreases substantially continuously along its length towards the secondary waste outlet 226 of the so that waste material conveyed by the secondary feed screw 232 becomes increasingly compacted as it is conveyed along the secondary feed duct 206.

In this embodiment, the pitch reduces by a factor of 2:1 over the length of the feed duct 202. The secondary feed screw 232 has a pitch of 380 mm towards the end wall 222 or secondary waste inlet 224 and a pitch of 190 mm towards the secondary waste outlet 226 of the secondary feed duct 202.

As shown in FIG. 3, in the feed assembly 200 further comprises a rotary drive controller 242 for the secondary rotary drive 240 and a power supply 243 for the secondary rotary drive 240. The rotary drive controller 242 is configured to control the power supplied to the secondary rotary drive 240, and thereby influences the torque and/or rotary-output-speed of the secondary rotary drive 240.

The rotary drive controller 242 is coupled to a rotational resistance sensor 244 configured to monitor a parameter relating to the resistance to rotation. In this embodiment, the sensor 244 is a torque sensor disposed on an output shaft of secondary rotary drive. The torque sensor is a surface acoustic wave (SAW) sensor for detecting the torque load applied by the output shaft. In other embodiments the torque sensor may be a torsion stain gauge. In principle, this torque load corresponds to the torque load of the secondary shaft 228 and the feed screw 232 as rotating components of the feed assembly, and so the torque sensor could be disposed on any one of these rotating components. In other embodiments, the rotational resistance sensor 244 may be a power meter configured to monitor the power consumption of the secondary rotary drive, which is indicative of the resistance to rotation experienced by the rotating components to achieve a constant or known rotary-output-speed.

The rotary drive controller 242 is configured to drive the secondary shaft and feed screw 228, 232 at a constant rotary-output-speed under normal operating conditions, such as 4 revolutions per minute (0.418 radians per second). The rotary drive controller 242 is configured to monitor the output of the sensor 244 to determine whether the resistance to rotation is excessive, and is configured to reduce the rotary-output-speed reduces when it is determined that the resistance to rotation is excessive, as will be described in detail below.

The secondary rotary drive 240 is linked to the primary rotary drive (not shown) so that the mass feed rate of waste is consistent between the primary and secondary feed ducts 204, 206.

In use, waste material is tipped into the hopper 202 where it is received in the rotary drum airlock 203. The rotary drum airlock 203 periodically rotates to transfer waste received therein into the hopper duct 208 and into the primary feed duct 204 through the primary waste inlet 210. The waste falls onto the primary feed screw 212 and primary shaft 213 within the primary feed duct 204. The primary rotary drive causes the primary feed screw to rotate at 4 revolutions per minute (0.4184 radians per second) and the helical flights of the primary feed screw 212 convey the waste along the primary feed duct 204 towards the primary waste outlet 214 and the secondary feed duct 206. As the waste passes the conical portion and wide portion of the shaft 220, 218 the waste is compacted owing to the reduced cross-sectional area in the duct, and seals against the internal wall of the primary feed duct 204 (and against the shaft 213), thereby forming a plug seal in the primary feed duct 204.

The waste processing apparatus is operated at negative pressure relative to ambient air pressure to prevent leakage of pyrolysis gas or syngas from the apparatus. Accordingly, the plug seal in the primary feed duct 204 inhibits the ingress of outside air into the waste processing apparatus.

The waste is conveyed from the primary feed duct 204 into the secondary feed duct 206 at the junction therebetween. The secondary rotary drive 240 causes the secondary shaft and secondary feed screw 228, 232 to rotate at 4 revolutions per minute (0.4184 radians per second) corresponding to the standard rotary-output-speed of the secondary rotary drive 240. In this embodiment, the rotary drive controller 242 controls the secondary rotary drive 240 to operate at a standard rotary-output-speed, and will adjust the power supplied to the secondary rotary drive 240 so that the secondary rotary drive 240 applies sufficient torque to reach the rotary-output-speed. In other embodiments, different control loops could be established.

The rotating helical flights of the feed screw 232 cause the waste to be conveyed from the secondary waste inlet 224 to the secondary waste outlet 226 and into the rotary pyrolysis tube 302.

The waste is progressively compacted as it moves along the feed duct 206 and the pitch of the secondary feed screw 232 reduces. As the waste is compacted, voids between the waste, the internal wall of the feed duct 206, the shaft 228 and the flights of the feed screw 232 are gradually reduced until the waste is sufficiently compacted to seal against the internal wall of the feed duct 206 (and against the shaft 228), thereby forming a plug seal in the secondary feed duct 206. Again, the plug seal inhibits the ingress of outside air into the waste processing unit.

In this embodiment, the secondary feed duct 206 is of constant internal diameter, but in other embodiments the feed duct 206 may have a compaction cone to assist in the compaction of the waste. Alternatively, or in addition, the diameter of the shaft 228 may increase towards the secondary waste outlet to compact the waste.

It will be appreciated that during a start-up phase of the feed assembly there will be no seal between the waste and either the primary or secondary feed ducts 204, 206. Accordingly, oxygen from the ambient air may enter the pyrolysis tube 302. However, this small amount of oxygen will be used in a combustion reaction in the waste processing apparatus and eliminated during a short period of operation of the pyrolyser 300. Further, the amount of ambient air within the feed assembly may be limited by the rotary drum airlock 203.

The provision of a variable pitch feed screw means that the waste can be compacted to move radially outwardly and seal against the feed duct. The applicant has found that a seal of this type can be formed reliably and with a relatively low torque on the feed screw (i.e. driven power) when compared with previously considered feed assemblies, in particular feed assemblies having a constant pitch feed screw and a feed duct with a compaction cone. Further, the applicant has found that the variable pitch feed screw is less susceptible to blockages than the compaction cone arrangement, which may be at least partly due to the flights having the same clearance with respect to the duct along the length of the feed duct, as opposed to having a reducing clearance in the region of a compaction cone.

If a blockage occurs in the feed assembly 200, for example in the secondary feed duct 206, the rotary pyrolysis tube 302 or between the two, the blocked waste will resist rotation of the feed screw and the torque required from the secondary rotary drive 240 to maintain the rotary-output-speed of the drive 240, shaft 228 and feed screw 232 will increase. The rotary drive controller 242 initially provides increased power to the rotary drive to maintain the rotary-output-speed, whilst monitoring the output of the sensor 244, which in this embodiment is a torque sensor coupled to an output shaft of the secondary rotary drive 240. If the torque sensor indicates that the resistance to rotation is excessive (i.e. that a blockage is likely to have occurred), the rotary drive controller 242 will reduce the power supplied to the rotary drive so as to reduce the rotary-output-speed of the secondary rotary drive 240, secondary shaft 228 and secondary feed screw 232 in response to the blockage. This may reduce the risk of the waste processing apparatus 100 becoming fully blocked and being taken out of service, since the blockage may be able to clear whilst the feed screws 212, 232 (which are linked via their respective rotary drives) turn at a reduced rate, and the mass feed rate of the feed assembly is correspondingly reduced. The rotary drive controller 242 continues to monitor the output of the sensor 244, and if it is determined that the resistance to rotation is no longer excessive (i.e. the blockage may have cleared), then the rotary drive controller 242 increases the power supplied to the secondary rotary drive 240 so as to increase the rotary-speed-output of the drive 240 to the standard speed. The controller 242 may be configured to increase the rotary-speed-output after a predetermined delay, such as 10 seconds after it is determined that the resistance to rotation is no longer excessive.

In this embodiment, the sensor 224 is a torque sensor that outputs the actual torque load on the output shaft of the secondary rotary drive 240, and the rotary drive controller 242 is configured to determine that the resistance to rotation is excessive when the torque load is above a threshold torque of 13000 Nm, or when the rate of change of torque load is above a threshold rate of 11000 Nm per second (Nm/s).

In this embodiment, the rotary drive controller 242 is configured to have different responses dependent on which threshold is exceeded. In particular, the rotary drive controller 242 is configured to decrease the drive speed by increments of 0.5 revolutions per minute once every 4 seconds when the rate of change of torque load exceeds the respective threshold until both the absolute torque load and the rate of change of torque load are below the respective thresholds. However, the rotary drive controller is configured to reduce the drive speed so that the rotary drive temporarily reverses when the torque load exceeds the absolute torque threshold.

In other embodiments, there may be several absolute torque thresholds. For example, there may be a first threshold torque, for example 13000 Nm, and the rotary drive controller may be configured to incrementally reduce the drive speed when the torque load exceeds this threshold. Further, there may be a second threshold torque, for example 15000 Nm, and the rotary drive controller may be configured to reduce the drive speed so that the rotary drive temporarily reverses when the torque load exceeds this threshold.

Accordingly, the feed assembly continues to operate despite determining that a blockage may be present, and operates to temporarily reduce the rotary-output-speed of the secondary rotary drive 240 (and so the primary rotary drive), thereby reducing the mass feed rate of the feed assembly 200 until the blockage is determined to have passed. The rotary-output-speed is then raised to the standard speed.

1-28. (canceled)

29. A waste processing apparatus comprising:
a pyrolyser; and
a feed assembly comprising:
a feed duct including a waste inlet configured to receive waste, wherein said feed duct further includes a waste outlet configured to discharge said waste from said feed duct to said pyrolyser;
a feed screw disposed within said feed duct configured to convey said waste from said waste inlet to said waste outlet;
a rotary drive configured to cause said feed screw to convey said waste from said waste inlet to said waste outlet;
a rotational resistance sensor configured to monitor a parameter related to resistance to rotation; and
a rotary drive controller configured to reduce, based on said parameter, a rotary output speed of said rotary drive from a first rotary output speed to a second rotary output speed.

30. The waste processing apparatus of claim 29, wherein said rotational resistance sensor is a torque sensor configured to generate a signal related to a torque applied by said rotary drive to said feed screw.

31. The waste processing apparatus of claim 29, wherein said rotary drive controller is configured to reduce said rotary output speed of said rotary drive based on a condition selected from a group consisting of: a determination that said parameter is above a predetermined threshold; a determination that said parameter is outside a predetermined range; and a determination that a rate of change of said parameter exceeds a predetermined threshold.

32. The waste processing apparatus of claim 29, wherein said second rotary output speed is sufficient to convey said waste from said waste inlet to said waste outlet of said feed duct.

33. The waste processing apparatus of claim 29, wherein a direction of rotation associated with said first rotary output speed is opposite to a direction of rotation associated with said second rotary output speed.

34. The waste processing apparatus of claim 29, wherein said rotary drive controller is configured to increase, based on said parameter, said rotary output speed of said rotary drive.

35. The waste processing apparatus of claim 34, wherein said rotary drive controller is configured to increase said rotary output speed of said rotary drive based on a condition selected from a group consisting of: a determination that said parameter is below a predetermined threshold; a determination that said parameter is inside a predetermined range; and a determination that a rate of change of said parameter is below a predetermined threshold.

36. The waste processing apparatus of claim 29, wherein said rotary drive controller is configured to reduce said rotary output speed of said rotary drive by reducing power consumption of said rotary drive.

37. The waste processing apparatus of claim 29, wherein said rotary drive is configured to rotate said feed screw relative to said feed duct at said rotary output speed of said rotary drive.

38. A method of operating a waste processing apparatus, said method comprising:
receiving waste in a feed duct of a feed assembly, wherein said receiving further comprises receiving said waste via an inlet of said feed duct, and wherein said feed assembly comprises a feed screw disposed within said feed duct;
controlling a rotary drive of said feed assembly to cause said feed screw to convey said waste from said waste inlet to a waste outlet of said feed duct, wherein said controlling further comprises controlling said rotary drive to cause said feed screw to discharge said waste from said feed duct to said pyrolyser;
monitoring a parameter related to resistance to rotation; and
controlling said rotary drive to reduce, based on said parameter, a rotary output speed of said rotary drive from a first rotary output speed to a second rotary output speed.

39. A waste processing apparatus comprising:
a pyrolyser; and
a feed assembly comprising:
a feed duct including a waste inlet configured to receive waste, wherein said feed duct further includes a waste outlet configured to discharge said waste from said feed duct to said pyrolyser; and
a feed screw disposed within said feed duct configured to convey said waste from said waste inlet to said waste outlet, wherein a pitch of said feed screw reduces along its length in a direction from said waste inlet to said waste outlet such that said feed screw is configured to compact said waste conveyed from said waste inlet to said waste outlet.

40. The waste processing apparatus of claim 39, wherein said pitch of said feed screw reduces along its length in a direction from said waste inlet to said waste outlet such that said feed screw is configured to compact said waste so as to form a seal against said feed duct.

41. The waste processing apparatus of claim 39, wherein said pitch of said feed screw reduces along its length in a direction from said waste inlet to said waste outlet such that said feed screw is configured to compact said waste so as to form a seal against a portion of said feed duct having a constant diameter.

42. The waste processing apparatus of claim 39, wherein said pitch of said feed screw reduces along its length in a direction from said waste inlet to said waste outlet such that said feed screw is configured to compact said waste so as to form a seal against a portion of said feed duct having a tapering diameter.

43. The waste processing apparatus of claim 39, wherein said feed screw is configured to compact said waste against said feed duct responsive to rotation of said feed screw relative to said feed duct.

44. The waste processing apparatus of claim 39, wherein said feed screw is substantially coextensive with at least a portion of said feed duct.

45. The waste processing apparatus of claim 39, wherein said feed screw is coaxially disposed within at least a portion of said feed duct.

46. The waste processing apparatus of claim 39, wherein said feed duct includes a primary feed duct and a secondary feed duct, wherein said primary feed duct includes said waste inlet configured to receive said waste, wherein said primary feed duct further includes another waste outlet configured to discharge said waste from said primary feed duct to said secondary feed duct, wherein said secondary feed duct includes another waste inlet configured to receive said waste from said primary feed duct, and wherein said secondary feed duct further includes said waste outlet configured to discharge said waste to said pyrolyser.

47. The waste processing apparatus of claim 46, wherein said feed screw is disposed within a portion of said feed duct selected from a group consisting of said primary feed duct and said secondary feed duct.

48. The waste processing apparatus of claim 46, wherein said feed screw is disposed within said primary feed duct, and wherein said feed assembly further comprises:
another feed screw disposed within said secondary feed duct configured to convey said waste from said another waste inlet to said waste outlet, wherein a pitch of said another feed screw reduces along its length in a direction from said another waste inlet to said waste outlet such that said another feed screw is configured to compact said waste conveyed from said another waste inlet to said waste outlet.
